(19) United States
(12) Patent Application Publication
(10) Pub. No.: US 2003/0177845 A1
(43) Pub. Date: Sep. 25, 2003

(54) Torque measurement of hydraulic installer of earth anchor

(76) Inventor: Edward Dziedzic, Shelby, TN (US)

Correspondence Address: PAUL M. DENK, 763 South New Ballas Rd., St. Louis, MO, 63141, US

(21) Appl. No.: 09/978,266

(22) Filed: Oct. 15, 2001

Related U.S. Application Data
(60) Provisional application No. 60/239,952, filed on Oct. 16, 2000.

(51) Int. Cl. G01L 3/14

(52) U.S. Cl. 73/862.27; 73/862.37

(57) ABSTRACT

A torque measurement of hydraulic installers for earth anchors, designed to sense hydraulic pressure and translate it into a torque output, through the use of transducers, regulator, and usually battery operated. By measuring the differential in supply pressure and return pressure transducers calibrating the same, thus furnishing a torque read-out, in foot pounds, of the amount of torque being applied by the installer when driving an earth anchor into the ground.

### BACKGROUND OF THE INVENTION

This invention relates principally to a device for measuring the torque generated by an hydraulic installer when installing an earth anchor into the ground.

Installers for driving earth anchors, such as through a Kelly bar, into the ground, have long been available in the art. Usually, such anchors are provided to achieve just that, the anchoring of an end of, for example, a cable, or other brace, that is designed for stabilizing the installation of a tower, pole, or other instrument, or for whatever use anchors may be installed deeply into the ground, during application. For example, anchors may also be used for supporting foundations, or other structures.

An example of an anchor torque controller, that provides a gauging of the amount of torque generated when installing an anchor into the ground, can be seen in the assignee's prior U.S. Pat. No. 5,570,577, upon Anchor Torque Controller for Anchor Installing Machines. The reason for such a regulator, is exactly as described in the patent, and that is to provide means for regulating and limiting, in addition to controlling, the amount of torque generated by a motor, when driving an anchor into the ground, so that it does not exceed specified forces, that could lead to a fracture of the anchor, when installed, and failure when implemented.

The measurement of torque output of hydraulic diggers of the type used to install auger type (helical plate) anchors, has been a difficult problem over the years. A shear pin type of indicator has been used to limit the torque by shearing calibrated pins, but such an instrument is difficult to use, has questionable or poor accuracy, and is subject to maintenance problems. Likewise, electronic devices attached in-line with the installing tool train, such as the Kelly bar, wrench tubes, etc., are usually not durable enough to withstand the wear and tear of the excessive G forces generated during difficult anchor installations. Some methods have tried to employ hydraulic pressure as a measuring means, but generally have been frustrated by the changing oil temperature and viscosity which makes the relationship between the pressure and driving torque an unreliable variable, providing usually indefinite read-outs, that are quite inaccurate.

### SUMMARY OF THE INVENTION

This invention relates generally to earth anchors, and their installation, but more specifically provides means for accurately and electronically measuring the torque generated by the hydraulic installer when installing an earth anchor into the ground.

The device of this invention is designed to sense the hydraulic fluid pressure and translate it into a torque output. To avoid the problems of oil temperature and viscosity changes, the pressure is measured on both the driving side and exhaust side of the hydraulic motor, remote to the drive train. Being remote to the drive train also avoids the damaging effects of vibrations from G-forces during the installation.

The proposed design combines two sensors, electronically, with appropriate compensation for individual sensor differences to compute the differential pressure applied to the hydraulic motor. The hydraulic motor manufacturers have established differential pressure as a highly accurate measure of motor torque, when properly calibrated. The proposed invention consists, typically, of a pair of pressure sensors with appropriate mounting means, connected by a cable to an electronic read-out similar to a digital volt meter. The electronic circuitry of the read-out is designed to provide excitation to the sensors, as well as compensating circuitry for variations in sensor characteristics, along with a means for calibrating the reading to show the torque generated on the display. The torque reading is directly related to the corrected pressure differential, but is also some multiple of the actual voltage or current differential generated by the sensors. The circuitry to generate the appropriate multiple and thus calibrate the read-out for a wide variety of motor types, is provided within the read-out device.

This invention incorporates electronic transducers and a digital display that lets the user accurately read the torque output of the drive motor. It displays torque delivered to the anchor shaft directly in foot pounds. The transducers are attached to the fluid supply and return lines of the hydraulic anchor installer. Based upon the principle of differential pressure, or pressure drop across the hydraulic motor, each unit is calibrated to a specific drive motor.

A typical complete assembly consists of a small rectangular solid manifold or other means of attaching sensors with inlet and outlet ports that monitor the supply pressure and return lines. Two solid-state, strain-gauge sensors, one for the pressure side, and one for the return line side, individually sense the pressure on these two lines. The signals are transmitted to the read-out via a multi-wire cable that remotely connects to the display unit. This cable may be disconnected and stored when not in use.

The sensors are usually mounted in a steel case to protect the strain gauges against impact, fluid leaks or exposure to the weather, oils, gases, and the like. These gauges are capable of adjustment to provide a plus or minus 1% of full scale accuracy.

In usage the cable is connected between the digital display package and the manifold/sensor unit, as provided, and then a toggle switch is actuated to read the torque motor output in foot pounds. Then, one reads or records the actual anchor installation torque. The pressure differential, which is sensed, is translated into torque by the circuitry.

It is, therefore, the principal object of this invention to provide for an electronic torque measuring device to furnish a precise torque output so the installer knows exactly and continuously the amount of force being generated to drive an anchor into the ground.

Another object of this invention is to provide a compact unit for an electronic torque transducer and display means, that furnishes very accurate torque readout during installation of an anchor into the ground.

A further object of this invention is to provide for a very compact electronic device for determining precisely the torque output of an anchor installer, and which can be very easily connected to a portion of the hydraulic installer rather promptly during usage.

These and other objects may become more apparent to those skilled in the art upon reviewing the summary of the invention as provided herein, and upon undertaking a study of the description of its preferred embodiment, in view of the drawings.

### BRIEF DESCRIPTION OF THE DRAWINGS

In referring to the drawings:

FIG. 1 is an isometric view of the electronic read dash out display unit that translates the measured torque into a digital readout of the torque output of the anchor installer;

FIG. 2 is an isometric view of the same electronic read-out device, showing its display, and toggle switch;

FIG. 3 is a front view of the torque measuring device which measures the high and low pressure differential during operations of the anchor installer, and which fluid pressure is measured by the strain-gage sensors which provide data to the electronic read-out for determination of the amount of torque experienced during driving of the anchor;

FIG. 4 is a side view of the hydraulic sensors, with a part of the side guard being removed to expose the hydraulic pressure sensors;

FIG. 5 is a block diagram of the circuit logic of the invention; and

FIG. 6 is a circuit diagram of the various components for this torque measuring device.

### DESCRIPTION OF THE PREFERRED EMBODIMENT

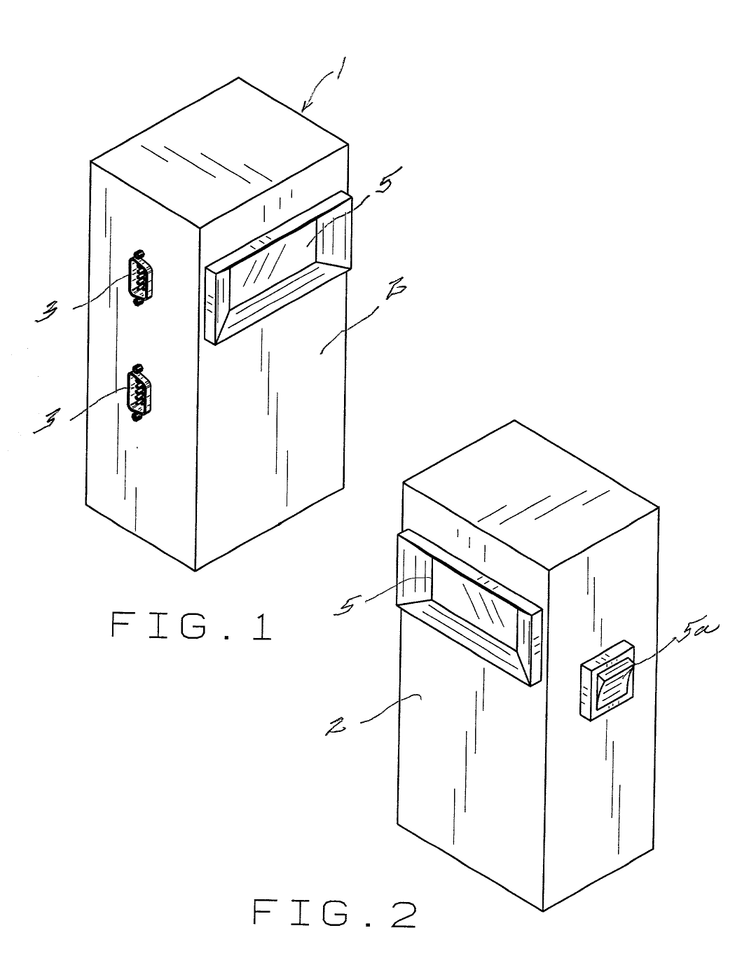

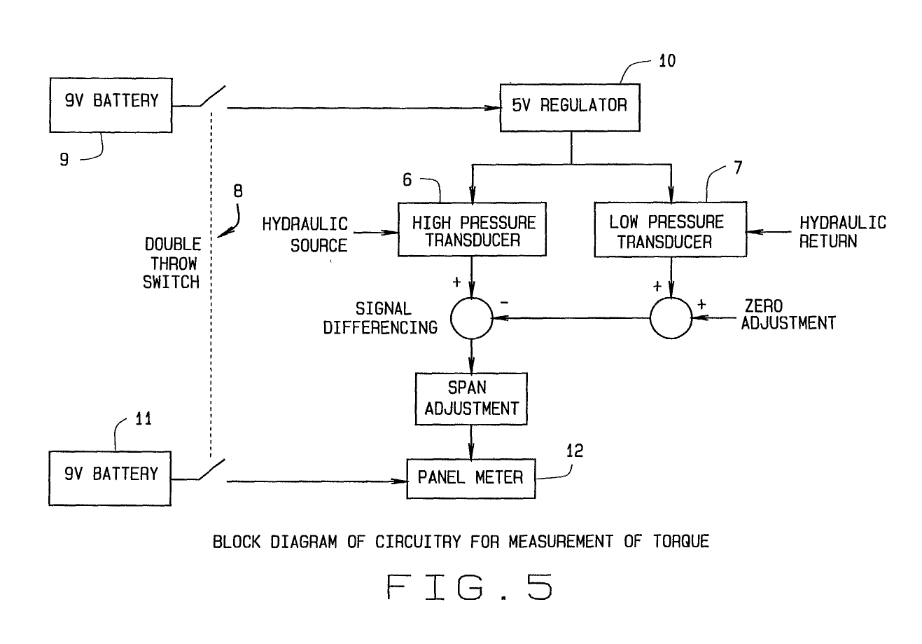

In referring to FIG. 1 of the drawings, the invention, basically comprising an electronic torque transducer and display unit, as at 1, is readily disclosed. As can be seen, the invention includes the unit 2 itself, having its various cabling connectors 3, the sensors 4 (see FIG. 4) and the electronic read-out 5 that provides information relevant to the installer, as to when the proper torque is being applied when driving an earth anchor into the ground.

FIG. 2 discloses the unit 2 incorporating its covering means 3 (not shown), so that the device, when used out in the field, may be resistant to occasional abuse that may occur such as through dropping, bumping, of the entire sensitive instrument package, when employed for detecting, rather precisely, the amount of torque experienced. A toggle switch 5A can toggle between the high and low pressure measurements.

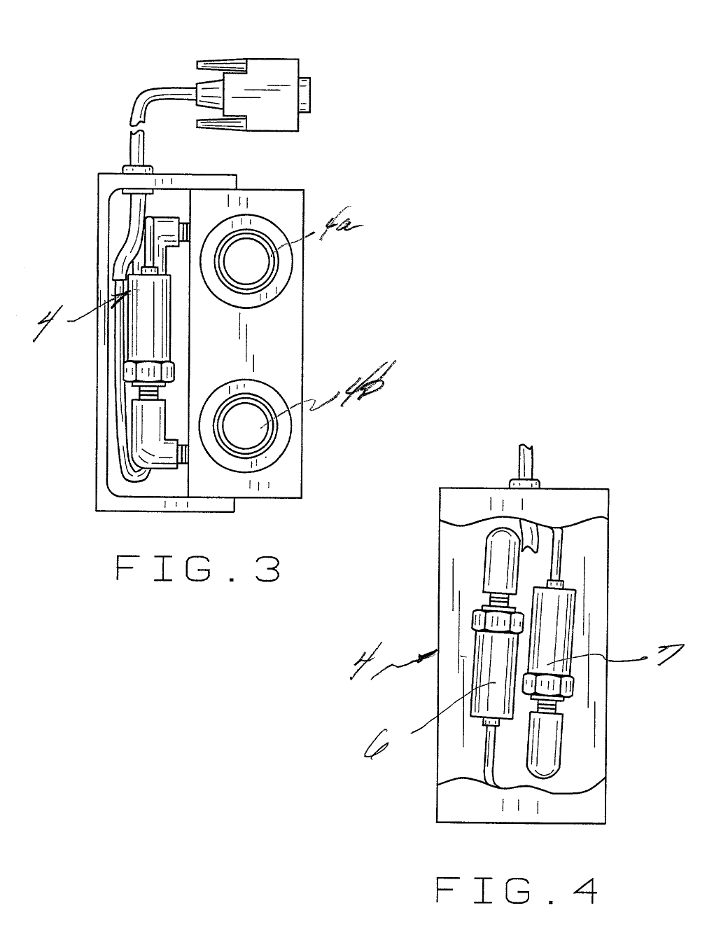

FIGS. 3 and 4 disclose the toque measuring device, generally at 4, and which includes a pair of hydraulic fluid measuring cylinders, which include a high pressure transducer 6 and a low pressure transducer 7, which effectively measure the high and low fluid pressures during operation of the installer, and which cooperates with sensors, to determine a pressure differential as applied by the hydraulic motor. There are 2 solid-state, strain-gage sensors, one for the fluid pressure line side, and the other for the return hydraulic fluid line side, which individually sense the pressure on the two lines, and then determine a read out as to the amount of pressure being applied at these differentials.

As can also be seen in FIG. 3, there are fittings to either side of the torque measuring device 4, each of the fittings 4A and 4B provided for connecting within the hydraulic supply and return lines to allow access of the transducers and gages 6 and 7, respectively, to measure the fluid pressure in both of said lines. Similar fittings are provided on the back side of the device 4, to provide a flow through of the hydraulic fluid in both the supply and return lines.

FIG. 5 discloses a block diagram of the circuit logic of this particular invention. Basically, the primary purpose of the circuit is to take the electrical output from two individual sensors, and determine their electrical difference, so that the amount of torque generated can be calibrated. This circuit accomplishes this task by utilizing passive components, without amplifiers, to avoid much of the drift in temperature problems inherent in amplifying these types of signal from components. Generally, this circuitry works with the use of the two transducers, the high pressure transducer 6, and the low pressure transducer 7, which are connected, respectively, for detecting pressure at the hydraulic source that is used for driving the installer, and for also measuring the low pressure in the hydraulic return line, operating with the same installer. These transducers have a 0.5 volt to 4.5 volt output range, or related voltage ranges, with the current output transducers having an amperage measuring means from 0 mil-amps to 20 mil-amps, and 4 mil-amps to 20 mil-amps in current measurement. The circuit shown is tailored to work well with the 0.5 volt to 4.5 volt transducers, provided with a regulated source of 5.0 volts. Through these transducers, the pressure is measured, converted to current, providing an amperage output that can be processed by the circuitry of this invention.

A double throw switch, as at 8, connects to a battery, such as a 9 volt battery 9, as noted. The charge is conducted to a regulator 10, to supply the 5 volts needed for the circuit and pressure transducers, and simultaneously connects a second battery, as at 11, to provide the power for a panel meter 12 that furnishes a display.

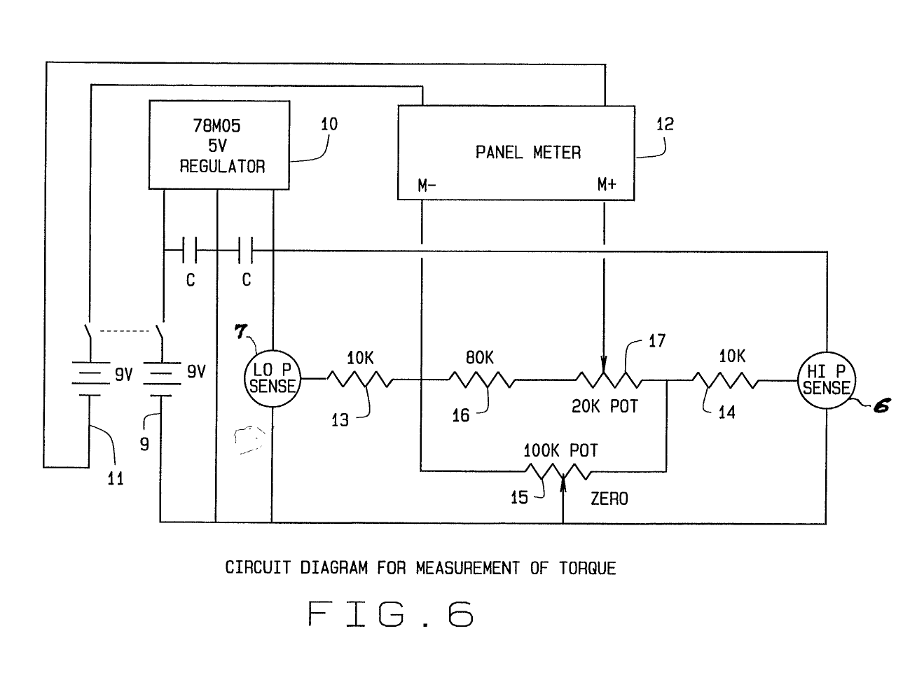

In referring also to FIG. 6, the transducer outputs are conducted through 10 kilo-ohm resistors 13 and 14, and conduct their charge to the 100 kilo-ohm potentiometer 15, used to zero the measurement when pressures are equal. In addition, a parallel conductive path is provided including an 80 kilo-ohm resistor 16 furnished in series with a 20 kilo-ohm potentiometer 17, that is used to adjust the differential signal to a level suitable for display. In this case, for example, a 200 mil-volt signature corresponds to 2000 ft. pounds of torque, with proper calibration and the correct pressure transducers.

With only slight modification of resistor and potentiometer values, the range can be adjusted to allow measurement of lesser or greater pressures. In addition, the panel meter is not essential since the circuit also permits the use of a multi-meter or other measurement device in which the case the second battery is then included in the meter.

Although a number of variations of this circuit are possible to accommodate various read-out devices and pressure transducer types, the common characteristic is a passive subtraction of the two transducer signals. The circuit shown here uses a voltage subtraction technique, but can be modified for current output pressure transducers by using a current subtraction.

Further advantages of this invention include:

a means of remotely reading the torque output of hydraulic digger motors commonly used to install earth anchoring devices, thus enabling the installer to realize immediately the quality of the anchor installation, such as potential pull out strength, proper depth of earth penetration, and whether the installing system is in danger of over-torque failure;

a hydraulic/electronic device which can electro-mechanically measure with high accuracy, the hydraulic pressure drop across a hydraulic motor and provide circuitry to vary the resulting electronic voltage or current output of the sensor means to display a linear multiple of that signal so that the readout requires no further interpretation;

the device as previously described above, with an electronic means for recording the output so that actual installing information such as time and applied torque are preserved without the need for manual recording;

a device which provides a low cost means of measuring differential pressures using two single sensors rather than more complex, expensive, and range-limited, integrated differential devices.

Variations or modifications to the subject matter of this invention may occur to those skilled in the art upon reviewing the disclosure as provided herein. Such variations, within the scope of this development, are intended to be encompassed within the invention as described herein. The description of the preferred embodiment, as furnished herein, is done so for illustrative purposes only.

I claim:

1. A torque measuring device for hydraulic installer for earth anchor, including a torque measuring housing, means provided upon the housing for connecting the high and low hydraulic pressure lines to the installer, first and second transducers, each cooperating with a solid-state, strain-gage sensor, for determining the hydraulic fluid pressure generated in the supply pressure and return lines, respectively, during operation of the device, and for converting the determined pressure to an electrical signal, and an electronic read-out device electrically connected with the torque measuring device, to provide for a calculation and read out for display of the measured torque, whereby the torque generated by the hydraulic installer can be sensed and calibrated to furnish an accurate torque read-out in foot pounds of the amount of torque being applied by the installer when driving an earth anchor into the ground.

2. The torque measuring device for hydraulic installer for earth anchor of claim 1 including a toggle switch operatively associated with the device, within its circuitry, to provide for a read-out of the calculated high and low pressure measurements.

3. The torque measuring device of claim 1 wherein said first transducer senses and measures the high pressure generated in the hydraulic source, said low pressure transducer providing for a read-out for the low fluid pressure generated in the hydraulic pressure lines, means for converting said high and low pressure determinations to electrical signals, means for providing a determination of the signal difference between the high and low pressures detected, and a panel meter provided upon the torque measuring device furnishing an analog read-out in foot pounds of the amount of torque being applied by the installer when driving an earth anchor into the ground.

4. The torque measuring device of claim 3 wherein said signal differencing means includes a potentiometer, provided for calibrating the device to zero when the measurements of the detected pressures are equal.

5. The torque measuring device of claim 4 and including battery means operatively associated with the electrical circuitry to provide the levels of voltage necessary for operations of the sensors, transducers, and potentiometer during processing of generated signals to provide a read-out in foot pounds of the amount of generated torque.
